(19) United States
(12) Patent Application Publication
(10) Pub. No.: US 2014/0010730 A1
(43) Pub. Date: Jan. 9, 2014

(54) APPARATUS FOR MICRODROPLET GENERATION VIA LIQUID BRIDGE BREAKUP

(71) Applicant: POSTECH ACADEMY-INDUSTRY FOUNDATION, Gyeongsangbuk-do (KR)

(72) Inventors: Dustin Moon, Gyeongsangbuk-do (KR); In Seok Kang, Gyeongsangbuk-do (KR); Do Jin Im, Gyeongsangbuk-do (KR)

(73) Assignee: POSTECH ACADEMY-INDUSTRY FOUNDATION, Gyeongsangbuk-do (KR)

(21) Appl. No.: 13/776,961

(22) Filed: Feb. 26, 2013

(30) Foreign Application Priority Data
Jul. 3, 2012 (KR) 10-2012-0072124

(51) Int. Cl. B01L 3/00

(52) U.S. Cl. CPC B05B 17/0692
USPC 422/500

(57) ABSTRACT

An apparatus for microdroplet generation via liquid bridge breakup, which can efficiently generate microdroplets using liquid bridge breakup without using a complicated mechanical device. The apparatus includes: two substrate plates having respective hydrophilic surfaces; a protrusion provided on a side surface of either of the two substrate plates so as to maintain a predetermined space between the two substrate plates; and a spacer provided on ends of the two substrate plates and spacing the two substrate plates from each other, thereby inducing liquid bridge breakup.

### CROSS-REFERENCE TO RELATED APPLICATIONS

This application claims priority to Korean Patent Application No. 10-2012-0072124, filed Jul. 3, 2012, the entire contents of which are hereby incorporated by reference herein.

### FIELD OF THE INVENTION

The present invention relates, in general, to microdroplet generation apparatuses and, more particularly, to a microdroplet generation apparatus that can efficiently generate microdroplets using liquid bridge breakup without using a complicated mechanical device.

### BACKGROUND

Microdroplets may be used for various purposes. In the related art, examples of methods that can be applied in order to generate one microdroplet at a time are limited to a method using an electric field effect and to a method using a piezoelectric (PZT) effect. Of the two methods, the method using the PZT effect is more preferably used in the related art from the viewpoints of processes and purposes. However, the method using the PZT effect is problematic in that, when it is used to generate microdroplets including sensitive particles, such as cells, a nozzle may become blocked or eject droplets unevenly.

In each of the two methods, a nozzle is used and so the sizes of generated droplets are in proportion to the size of the nozzle. Further, when the methods generate droplets, the sizes of the droplets are almost equal to the size of the nozzle. Accordingly, to generate smaller droplets through ejection, it is required to produce a nozzle having a smaller size, and this results in frequent blocking of the nozzle and an increase in the production cost.

Further, in the related art, the microdroplet generation may be realized by a variety of methods. However, in most methods, sensitive reactions may be induced by control parameters. Therefore, a change in the physical properties may cause a failure of the microdroplet generation. Further, methods using flow focusing or electro-spraying are problematic in that they cannot control the number of generated droplets and cannot efficiently generate droplets in an initial stage of microdroplet generation.

### SUMMARY

In an effort to solve these problems, the present invention is intended to utilize a droplet generation method that can efficiently generate droplets using liquid bridge breakup, in which a liquid bridge is formed by a surface tension, without using a nozzle, and breaks up, thereby generating microdroplets.

The liquid bridge breakup is a physical phenomenon that is generated in a liquid bridge when the ratio of the length of the liquid bridge to the diameter exceeds a predetermined level. Here, in the liquid bridge breakup, the liquid bridge is not evenly divided into two equal droplets, and a central portion of the liquid bridge remains and forms satellite droplets. The liquid bridge breakup is always generated in ideal fluids, such as water/oil. In the related art, to avoid the formation of satellite droplets in the liquid bridge breakup, most studies propose an application of surfactant or an electric field to the liquid bridge breakup. When the liquid bridge breakup is not specifically managed in these ways, satellite droplets are always formed and the formation of the satellite droplets may be usefully used in a proposed efficient droplet generation method.

Accordingly, the present invention has been made keeping in mind the above problems occurring in the related art, and the present invention is intended to propose a microdroplet generation apparatus, which, by a surface tension, forms a liquid bridge between two substrate plates having respective hydrophilic surfaces, and spaces the two substrate plates from each other using an additional spacer, thereby inducing liquid bridge breakup and generating microdroplets.

Another object of the present invention is intended to propose a microdroplet generation apparatus, in which a pipette that can induce microdroplets to be generated in a different fluid is combined, thereby preventing reunion of generated droplets and more efficiently generating microdroplets.

In order to achieve the above object, according to one aspect of the present invention, there is provided an apparatus for microdroplet generation via liquid bridge breakup, including: two substrate plates having respective hydrophilic surfaces; a protrusion provided on a side surface of either of the two substrate plates so as to maintain a predetermined space between the two substrate plates; and a spacer provided on ends of the two substrate plates and spacing the two substrate plates from each other, thereby inducing liquid bridge breakup.

In another aspect of the present invention, there is provided an apparatus for microdroplet generation via liquid bridge breakup, including: two substrate plates having respective hydrophilic surfaces, wherein the two substrate plates are formed in ends thereof into bent shapes so as to come into contact with each other, and include a spacer for spacing the two substrate plates from each other, thereby inducing liquid bridge breakup.

The two substrate plates may be made of a glass or metal material.

Each of the two substrate plates may be provided in a surface thereof with a pattern part that holds a liquid bridge.

Each of the two substrate plates may be provided with a nozzle that injects a liquid.

The spacer may use an elastic body or an electric or mechanical device.

The microdroplet generation apparatus may further include: a pipette provided on ends opposite to the ends having the spacer, the pipette induces microdroplets to be generated in a different fluid so as to prevent reunion of generated droplets.

As described above, the apparatus for microdroplet generation via liquid bridge breakup according to the present invention is advantageous in that the apparatus can always generate a single droplet or multiple droplets at a desired timing.

Further, another advantage of the present invention resides in that microdroplets are always generated irrespective of the properties of the liquid used, the sizes and number of the microdroplets are determined by the properties of the liquid used and, when a spacing speed of the spacer is in a predetermined range, the microdroplets have a predetermined size irrespective of a linear speed of ends of the liquid bridge.

A further advantage of the present invention resides in that it does not use or require a complicated structure, an advanced material or a cleanroom process when performing the microdroplet generation, and can efficiently generate microdroplets irrespective of outside control conditions or the moving speeds of the substrate plates.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating important parts of an apparatus for generating microdroplets via liquid bridge breakup according to the present invention;

FIG. 2 is a view illustrating an embodiment of the microdroplet generation apparatus according to the present invention, in which the apparatus is used in a directly sunk state in a different fluid;

FIG. 3 is a view illustrating another embodiment of the microdroplet generation apparatus according to the present invention, in which the apparatus has a construction suitable for being used with a pipette;

FIG. 4 is a view illustrating microdroplet generation via liquid bridge breakup in the microdroplet generation apparatus of the present invention;

FIG. 5 is a view illustrating actual microdroplet generation using the microdroplet generation apparatus according to the present invention, using a series of photographs prepared by continuous shooting; and

FIG. 6 is a view illustrating microdroplet generation via liquid bridge breakup using glass substrate plates, using a series of photographs prepared by continuous shooting.

### DETAILED DESCRIPTION

Hereinbelow, preferred embodiments of an apparatus for microdroplet generation via liquid bridge breakup according to the present invention will be described in detail with reference to the accompanying drawings. Wherever possible, the same reference numerals will be used throughout the drawings and the description to refer to the same or like parts. Further, in the following description, it is to be noted that, when the functions of conventional elements and the detailed description of elements related with the present invention may make the gist of the present invention unclear, a detailed description of those elements will be omitted.

Liquid bridge breakup is a physical phenomenon that is generated in a liquid bridge when the ratio of the length of the liquid bridge to the diameter exceeds a predetermined level. Here, in the liquid bridge breakup, the liquid bridge is not evenly divided into two equal droplets, and a central portion of the liquid bridge remains and forms satellite droplets. The liquid bridge breakup is always generated in ideal fluids, such as water/oil. In the related art, to avoid the formation of satellite droplets in the liquid bridge breakup, most studies propose an application of surfactant or an electric field to the liquid bridge breakup. When the liquid bridge breakup is not specifically managed in these ways, satellite droplets are always formed and the formation of the satellite droplets may be usefully used in a proposed efficient droplet generation method.

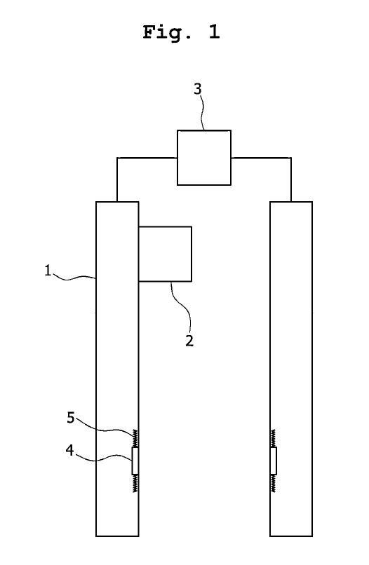

FIG. 1 is a view illustrating important parts of an apparatus for generating microdroplets via liquid bridge breakup according to the present invention;

The microdroplet generation apparatus of the present invention includes two substrate plates 1 having respective hydrophilic surfaces, a protrusion 2 that maintains a predetermined space between the two substrate plates 1, and a spacer 3 that spaces the two substrate plates 1 from each other, thereby inducing liquid bridge breakup.

The two substrate plates 1 are characterized in that they have the respective hydrophilic surfaces. Here, to allow a liquid bridge to be easily formed between the two substrate plates 1 by a surface tension, the two substrate plates 1 to which the hydrophilic surfaces are applied are used in the microdroplet generation apparatus. Here, a liquid bridge may be formed by directly sinking the two substrate plates 1 in a fluid or by supplying the fluid to the two substrate plates 1 from nozzles 5 of the two substrate plates 1. Further, to more efficiently form the liquid bridge, pattern parts 4 that have predetermined patterns may be provided in the two substrate plates 1 at locations at which the liquid bridge is formed.

When the apparatus uses the nozzles 5, the apparatus should be used at predetermined times or more because it is required to sufficiently use the nozzles 5, so that the apparatus loses the advantage in that it can be used with a small amount of reagent. However, the apparatus using the nozzles 5 provides an improved structural efficiency.

In the present invention, the substrate plates 1 may be made of glass or metal materials. In other words, the substrate plates 1 may be made of a variety of materials having hydrophilic properties.

In the present invention, the protrusion 2 may be formed on one of the two substrate plates 1 so as to allow the two substrate plates 1 to come into contact with each other. Alternatively, the above-mentioned contact of the two substrate plates 1 may be realized by forming ends of the two substrate plates 1 as bent ends without forming the protrusion 2 on the substrate plates 1. In the present invention, the protrusion 2 may not be formed on the substrate plates 1 according to the shape of the spacer 3. However, to induce efficient microdroplet generation, it is preferred that the microdroplet generation apparatus be provided with the protrusion 2 which is a spacing structure matching the sizes of the microdroplets.

To break up the liquid bridge, it is required to use the spacer 3. Here, the spacer 3 spaces the two substrate plates 1 from each other by a mechanical motion, thereby generating microdroplets. The above-mentioned mechanical motion may be formed by a device using an electric motor or using an elastic means, such as a spring.

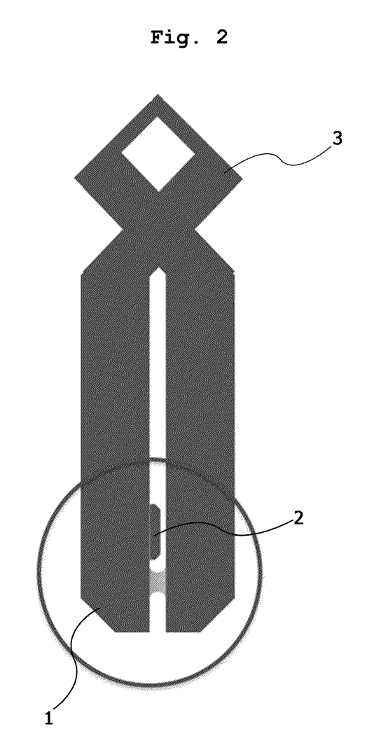

FIG. 2 is a view illustrating an embodiment of the microdroplet generation apparatus according to the present invention, in which the apparatus is used in a directly sunk state in a different fluid.

In this embodiment, to generate microdroplets, ends (shown in a circle in FIG. 2) of the two substrate plates 1 are sunk in a fluid so that a liquid bridge can be formed. After forming the liquid bridge, the spacer 3 is operated so as to space the two substrate plates 1 from each other, thereby inducing liquid bridge breakup. Here, as described above, to form the liquid bridge, the fluid may be directly supplied to the two substrate plates 1 from the respective nozzles 5 or the two substrate plates 1 may be sunk in the fluid.

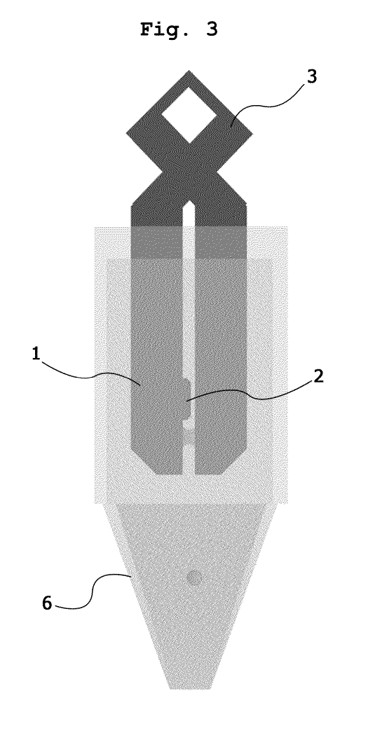

FIG. 3 is a view illustrating another embodiment of the microdroplet generation apparatus according to the present invention, in which the apparatus has a construction suitable for being used with a pipette 6.

In this embodiment, to prevent reunion of generated droplets during the microdroplet generation, an outside pipette 6 that can induce microdroplets to be generated in a different fluid is used.

In the outside pipette 6, a fluid having a property different from that of generated microdroplets is contained so that a generated fluid moves downward by gravity from the fluid having the different property, thereby generating microdroplets.

To induce liquid bridge breakup in a fluid having a property different from that of the generated microdroplets, the pipette 6 that contains therein the fluid having the different property is combined with the apparatus after forming the liquid bridge, and the spacer 3 is operated so as to generate microdroplets.

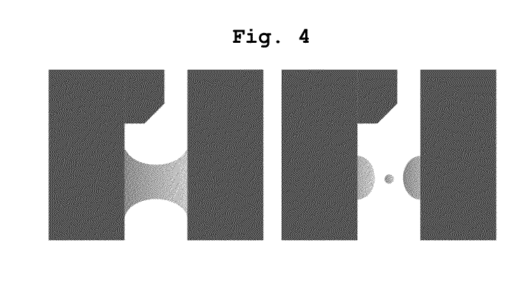

FIG. 4 is a view schematically illustrating microdroplet generation via liquid bridge breakup in the present invention, in which practical photographs are schematically shown so as to be easily observed.

The present invention can easily control the sizes of microdroplets and does not use an additional nozzle for inducing microdroplet generation, and so the present invention is advantageous in that it can solve the problems in the related art, such as the blocking of the nozzle. Another advantage of the present invention resides in that it can remarkably reduce the production cost compared to related art techniques.

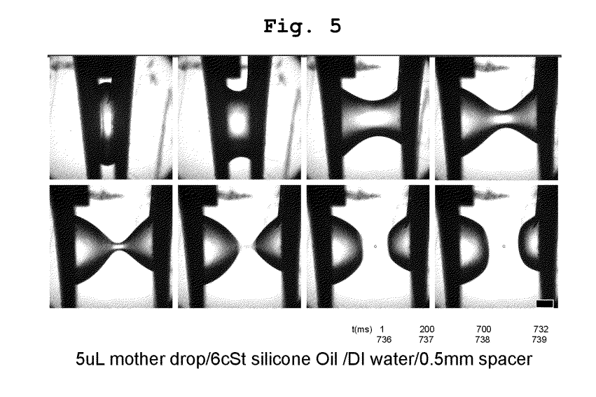

FIG. 5 is a view illustrating actual microdroplet generation using the microdroplet generation apparatus according to the present invention, using a series of photographs prepared by continuous shooting.

The photographs of FIG. 5 were obtained from continuous shooting of an end the microdroplet generation apparatus in which liquid bridge breakup is being induced. The photographs illustrate the microdroplet generation via liquid bridge breakup in detail.

Here, microdroplets are formed between the two substrate plates 1. Here, the sizes and number of the microdroplets are determined by the properties of liquid and, when a spacing speed of the spacer is in a predetermined range, the apparatus can generate microdroplets having a predetermined size irrespective of a linear speed of ends of the liquid bridge.

The present invention uses neither a complicated structure nor a cleanroom process, thereby reducing the production cost.

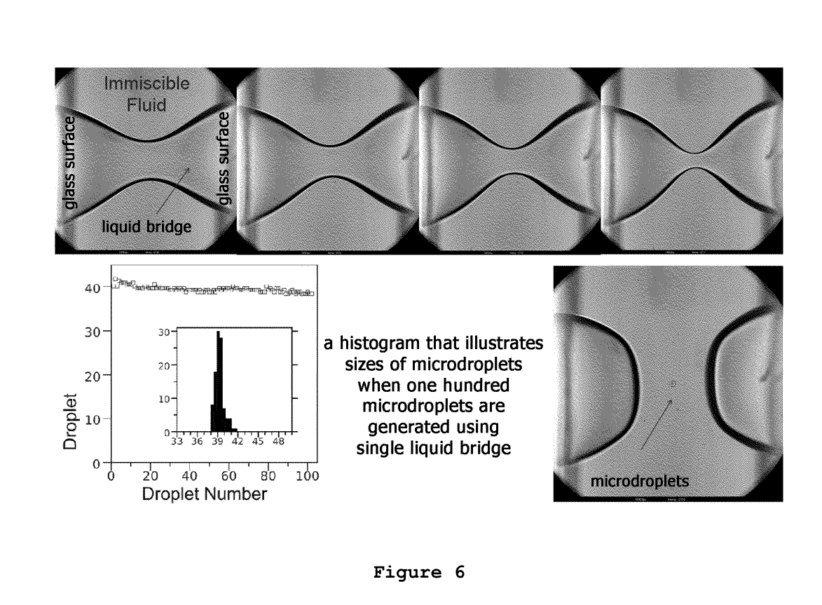

FIG. 6 is a view illustrating microdroplet generation via liquid bridge breakup using glass substrate plates, using a series of photographs prepared by continuous shooting. The photographs of FIG. 6 illustrate that a liquid bridge is formed between glass surfaces and, thereafter, breaks up when spacing the glass surfaces from each other. When the liquid bridge breakup is induced, microdroplets are generated.

The diagram in the lower end of FIG. 6 is a histogram that schematically illustrates the sizes of microdroplets when one hundred microdroplets are generated using a single liquid bridge. The histogram experimentally illustrates that the sizes of the generated microdroplets are almost equal to each other.

The microdroplet generation apparatus of the present invention can be efficiently adapted to applications in which it is required to form micro patterns directly by ejecting nanometer-sized microdroplets on substrate plates in various industrial fields requiring micro patterns, such as fields of semiconductors, displays, PCBs and solar batteries.

Further, the microdroplet generation apparatus of the present invention can generate microdroplets having various sizes using various kinds of fluid.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for microdroplet generation via liquid bridge breakup, comprising:
two substrate plates having respective hydrophilic surfaces;
a protrusion provided on a side surface of either of the two substrate plates so as to maintain a predetermined space between the two substrate plates; and
a spacer provided on ends of the two substrate plates and spacing the two substrate plates from each other, thereby inducing liquid bridge breakup.

2. The microdroplet generation apparatus as set forth in claim 1, wherein the two substrate plates are made of a glass or metal material.

3. The microdroplet generation apparatus as set forth in claim 1, wherein each of the two substrate plates is provided in a surface thereof with a pattern part that holds a liquid bridge.

4. The microdroplet generation apparatus as set forth in claim 1, wherein each of the two substrate plates is provided with a nozzle that injects a liquid.

5. The microdroplet generation apparatus as set forth in claim 1, wherein the spacer uses an elastic body or an electric or mechanical device.

6. The microdroplet generation apparatus as set forth in claim 1, further comprising:
a pipette provided on ends opposite to the ends having the spacer, the pipette induces microdroplets to be generated in a different fluid so as to prevent reunion of generated droplets.

7. An apparatus for microdroplet generation via liquid bridge breakup, comprising:
two substrate plates having respective hydrophilic surfaces, wherein
the two substrate plates are formed in ends thereof into bent shapes so as to come into contact with each other, and include
a spacer for spacing the two substrate plates from each other, thereby inducing liquid bridge breakup.

8. The microdroplet generation apparatus as set forth in claim 7, wherein the two substrate plates are made of a glass or metal material.

9. The microdroplet generation apparatus as set forth in claim 7, wherein each of the two substrate plates is provided in a surface thereof with a pattern part that holds a liquid bridge.

10. The microdroplet generation apparatus as set forth in claim 7, wherein each of the two substrate plates is provided with a nozzle that injects a liquid.

11. The microdroplet generation apparatus as set forth in claim 7, wherein the spacer uses an elastic body or an electric or mechanical device.

12. The microdroplet generation apparatus as set forth in claim 7, further comprising:
a pipette provided on ends opposite to the ends having the spacer, the pipette induces microdroplets to be generated in a different fluid so as to prevent reunion of generated droplets.
